(19) United States
(12) Patent Application Publication
(10) Pub. No.: US 2025/0165992 A1
(43) Pub. Date: May 22, 2025

(54) Genuine Scanner System & Method

(71) Applicant: Kathy Miller, Descanso, CA (US)

(72) Inventors: Kathy Miller, Descanso, CA (US); Kenny Fok, San Diego, CA (US)

(21) Appl. No.: 18/943,727

(22) Filed: Nov. 11, 2024

Related U.S. Application Data
(60) Provisional application No. 63/599,598, filed on Nov. 16, 2023.

(51) Int. Cl. G06Q 30/018; G06V 10/75; G06V 20/00

(52) U.S. Cl. CPC G06Q 30/0185; G06V 10/751; G06V 20/95

(57) ABSTRACT

An item authenticity evaluation system and/or method for user-provided images of an item considered for purchase are scored with a remote authentication system. User-provided images of the item are forwarded by an App on a handheld scanning/communication device (e.g., smart phone) to a server, which compares the images to one or more reference images of an authentic item. Various levels of information can be evaluated, including store name, location of item, etc. AI engines can be solicited for assistance and queries modified with a machine learning model. The system and/or method obviates the need for an in-person expert, is fast, and has access to resources that the in-person expert may not have.

### CROSS-REFERENCE TO RELATED APPLICATION(S)

This application claims the benefit and priority of U.S. Provisional Patent Application No. 63/599,598, titled “Genuine Scanner System & Method,” filed Nov. 16, 2023, the contents of which are hereby incorporated by reference in its entirety.

### FIELD

This invention relates to an authentication/verification method & system of physical items for purchase at a physical location. More particularly, it relates to an automatic (online tool) system that allows images of an item to be scanned/uploaded and via recognition software/services, a scoring is provided as to the authenticity of the item. Thus, a third party (e.g., software) can act as an “online expert” to the authenticity of the item being evaluated for purchase by a buyer.

### BACKGROUND

When a customer tries to purchase a product, especially a luxury item from a store, such as a high end watch, luxury bag, designer clothing, jewelry, scarf, etc., the customer may have concerns on the authenticity of the item being purchased. Is it really a Rolex, a designer scarf, or is it a fake? Currently, there is no easy or convenient way to determine if an item is authentic or not, from a customer's point of view, unless the customer is an expert-which is rarely the case. And even then, an in-person expert may only give an assessment of authenticity and not guarantee authenticity. Without some idea of the authenticity of an item, a bargain purchase can easily turn into wasted money. The only alternative is for the customer to visit an authorized dealer and even then, the product may not be as advertised. All of the existing methodologies do not provide a good answer to the customer, at the point of sale.

Accordingly, there has been a long standing need for a system and/or method to quickly validate the authenticity of an item, prior to purchase, without relying on the expertise of an in-store expert. Various such system(s) and method(s) are detailed below.

### SUMMARY

The above problems can be addressed by using a system(s) & method(s) of forwarding images of the item-for-purchase to an online/web recognition system that analyzes the item in the image and determines (via comparing to a stock or original item's images, as well as other data) whether the item appears to be authentic or not. The level of accuracy provided by the scanning/scoring system can be represented as a “score.” That is, a confidence (or un-confidence) score can be returned to the requesting potential customer. As an example, a particular scarf by a designer brand may have a unique pattern of colors and arrangement of striping that is well recognized by the public. However, a copycat scarf company may put out a near identical scarf pattern, having a very slight pattern change, one only an expert in the field could recognize as being fake. Or a particular color or length is slightly off. The average customer may not notice the slight difference. To avoid this, the customer could take one or more photos (scans, images, videos, etc.) of the scarf and send it to the exemplary authentication/scoring system, typically though an App on the customer's smart device/phone. The authentication/scoring system would evaluate the image(s), etc. sent in by the customer and using a comparative database, as well as applicable artificial intelligence engines, determine how “close” the image is to that of an authentic scarf by the designer brand. Depending on how close the correlation is, a scoring would be sent back to the customer and the customer could then make a more informed decision.

An aspect of various embodiments of an item authenticity evaluation system is provided, comprising: a computer-readable non-transitory medium having encoded thereon computer-executable instructions to: evaluate a user-provided image of an item by comparing the image to one or more authentic images of the item; determine a level of authenticity of the item; generate a score correlated to the level of authenticity determined; and an App configured for use on a portable smart device having image taking capabilities, wherein the App provides a client-side interface for the system and is configured to instruct the user to take one or more images of the item, to be evaluated by the system, wherein the system provides a measure of authenticity of an item being considered by the user.

In another aspect of various embodiments of the above system is provided, further comprising: a communications network; a smart device of the user having the App installed and configured to connect to the communications network; and a server connected to the communications network, wherein the server is configured to execute the instructions of the computer-readable non-transitory memory; and/or further comprising a database containing at least one of reference images of the item, feature descriptions of the item, and a location metric associated with the item being considered by the user; and/or wherein the computer-executable instructions further include instructions to: correspond with one or more artificial intelligence engines; and provide results of the correspondence as data used for determining the level of authenticity of the item; and/or wherein the computer-executable instructions further include instructions to perform at least one of an image correction, adjustment, and quality control of the user-provided image; and/or wherein the computer-executable instructions further include instructions to perform a weighting of the level of authenticity; and/or wherein results of the correspondence data are weighted; and/or further comprising, an analysis engine in communication to the system, providing at least one of the comparing the image to the one or more authentic images of the item and determining a level of authenticity of the item; and/or wherein the computer-executable instructions further include instructions to the user for additional information of least one of different user-provided images, a description of the item, a name of location venue, and stated price of the item, wherein information received from the user is used to assist in authentication; and/or further comprising a machine learning model, wherein the App forwards a buy or not-buy decision from the user to the machine learning model; and/or wherein at least one or more of the instructions are located on the machine learning model, wherein the machine learning model alters the evaluation and determination instructions.

In yet another aspect of various embodiments, a method of providing a confidence level of authenticity of an item to a customer is provided, comprising: installing an App on a user's smart device, the App configured to instruct the user to take at least one of images and a video of an item desired for purchase; sending the least one of images and video to a server-run application that evaluates the item within the at least one of images and video; determining the item type and brand within at least one of the App and the server-run application; comparing the at least one of images and video with images of an authentic item; generating at least one of a score and score range based on the comparing; and sending the at least one of score and score range to the App on the user's smart device, wherein the method provides a measure of authenticity of the item.

In yet another aspect of various embodiments of the above method is provided, wherein the comparing is accomplished by forwarding the least one of images and video to one or more artificial intelligence engines performing the evaluation, wherein the forwarding is based on a dynamic generated prompt using a machine learning model; and/or wherein a scoring of the one or more artificial intelligence engines is weighted; and/or wherein images of an authentic item are stored on at a database of the server running the evaluation or a database not local to the server; and/or the sending the at least one of score and score range to the App, includes sending a request for additional information of least one of different user-provided images, a description of the item, a name of location venue, and stated price of the item, wherein information received from the user is used to assist in authentication.

In another aspect of various embodiments, a genuine item scanning authentication system is provided, comprising: a communications network; a server connected to the communication network; portable smart device configured to communicate to the communications network; an App installed on the portable smart device, having image taking capabilities, wherein the App provides a client-side interface for the server and is configured to instruct a user to take one or more images an item under consideration, to be sent to the server; an intake module hosted by the server, evaluating received one or more images from App, wherein the intake module is configured to perform at least one of image correction, adjustment, and quality control of the user-provided images, and return instructions to the user if additional images or information is required, or a preliminary authentication score; an authentication module, comparing received information from the App with images of an authentic item and weighing a result of the comparing to arrive at an authentication score of the item under consideration; and a reply module hosted by the server, sending the authentication score to at least one of the App and the portable smart device.

In another aspect of various embodiments, the above system is provided, wherein the authentication module is in the form of a dynamic generated prompt with adjusted Machine Learning Model queries to at least one or more artificial intelligence servers and analysis engines connected to the communications network; and/or further comprising one more databases containing at least one of the images of an authentic item, characteristics of the item, and a location parameter of the item under consideration, for use in the authentication score; and/or further comprising, storing a buy or not buy decision by the user.

### BRIEF DESCRIPTION OF THE DRAWINGS

FIG. 1 is a flow diagram showing the operation of an exemplary system.

FIG. 2 is a block diagram highlighting a particular variant of the exemplary system.

FIG. 3 is a block diagram highlighting another particular variant of the exemplary system.

FIG. 4 is a sample flowchart of an exemplary method.

### DETAILED DESCRIPTION

As discussed above, the exemplary system(s) and method(s) is designed to assist in the evaluation of authenticity of merchandise being considered for purchase or sale. As counterfeiting, particularly of high value items, is common, it is helpful to a customer desiring to buy such merchandise, to be confident in their purchase. The exemplary system(s) and method(s) provide an easy customer-friendly mechanism to increase their level of confidence, by analyzing data forwarded by the user (typically photos or scans, but not limited to, of the merchandise) and returning with a scoring based on the provided information (and/or additional reply/request), using comparative information held in an automated database.

In one embodiment, the customer-side of the invention (e.g., App) could facilitate the taking of pictures (images, video, etc.) of each side of the merchandise, and/or instruct the customer to hold the item in a particular position, or on a body part (e.g., across shoulder, etc.). The App could send the pictures to the Cloud, the Cloud having a server(s) running the evaluation/scoring system for the received images/data. The Cloud could use basic 3rd party recognition services (such as Google Vision, Azure AI Vision, etc.) to at least identify the item, determine a type, a brand of the product. With a body-part image, the size of the merchandise could be assessed. A search engine could be invoked using key terms/values from the identification stage to acquire additional information on the item. Images could be sourced from the Internet or from a database accessible by the exemplary system/server(s). Machine learning tools may be used provide an analysis (e.g., how likely is this particular store, location, neighborhood, etc. to have fake products?). An aggregation module would aggregate all the information from any one or more of the above steps, and from this a weighting and/or scoring would be developed. The above information can be stored in a database for future reference. Iterative learning can be performed to enhance the expertise of the system. A final score or range of confidence (e.g., alphanumeric, color-key, A, B, or 50-75%, 75-90%, etc.) could be sent to user. The user's decision to buy or not buy could be recorded and kept for data keeping and future analysis (if user discovers the item is fake, this data could be updated into the system for feedback and tuning of the system).

While is it desirable, the exemplary system does not need to or may not be required to provide a 100% guarantee of authenticity, but can provide a grading of the assessment. That is, based on the images provided (quality, color, detail, etc.), the stock of reference images in the system's database, and comparison algorithms, the exemplary system would provide a confidence score to the customer. And based on this provided score, the customer can make a more “confident” decision on whether the item is more likely authentic or not.

While the below examples are in the context of a customer entering a merchandising establishment, the exemplary system(s) and method(s) may also be used in any suitable environment, or in a reverse manner. That is, a seller may wish to sell an item where the buyer may be a pawn shop or other cash-for-item dealer. Flea markets, street markets, purchases/sales from a private residence, and so forth are other possible venues where the exemplary invention may be practiced. Thus, the typical need for an expert person to come to the venue and examine the merchandise can be avoided, wherein a computerized and automated approach can be used as the expert proxy.

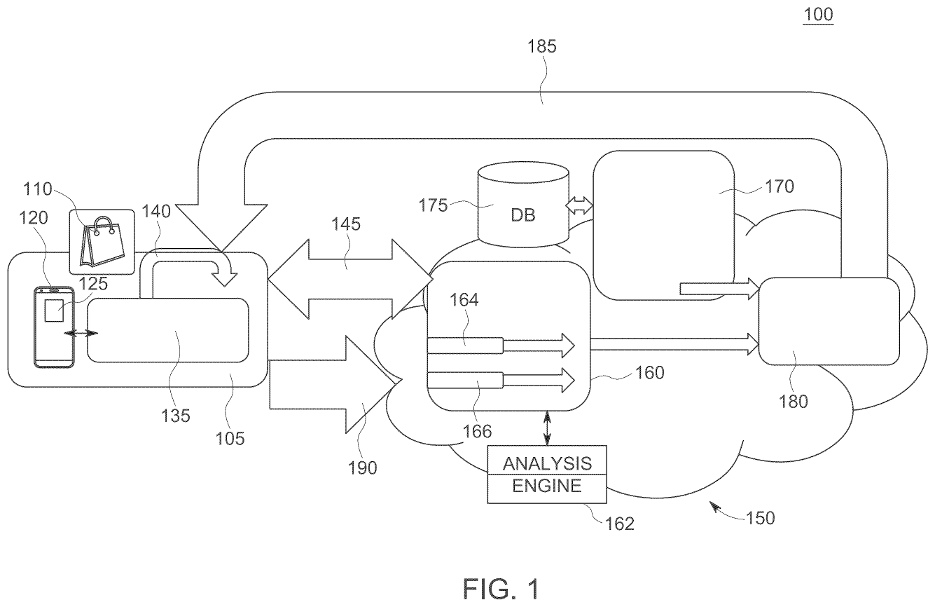

FIG. 1 is an illustration of a flow/block diagram 100 of an exemplary Scanner system in operation. A user (not shown) at a location, for example a store 105 that is providing the sale or purchase of an item 110 (shown here as a handbag, for example) has a scan-capable device, such as a portable smart phone 120. Other devices such as smart watch, intelligent glasses, smart pad, etc. may be similarly utilized, depending on the device capabilities. It is understood the customer's smart phone (smart device) 120 can scan or capture an image of the item 110.

A software program (typically an App) 125 on the smart phone 120 is initiated by the user to begin an evaluation of the authenticity or genuineness of the item 110 under examination. Authentication could be through the App 125 facilitating the authentication service or a related software “connected” to the authentication service. For an example of the latter, an SMS may be the means of providing an authentication score, or feedback, instead of via the App 125.

The exemplary App 125 responds to the user's authenticity request by prompting the user to perform one or more steps. These steps will instruct the user to take one or more photos (or scans or videos) of the item 110, wherein the images are forwarded via a local communication channel 140 to network cloud 150 for subsequent processing and evaluation. The local communication channel 140 can be cellular or internet based, or any other form of wireless communication.

In some instances, the App 125 may require preliminary user identification and/or registration, as well as some indication of the category of item being evaluated, as well as pricing. Other preliminary or subsequent requests and/or queries may be exchanged before or after the photos (or videos) are taken, so as to provide more information and better categorization of the item 110 being evaluated. In some instances, the App 125 may ask for the store's name (or determine it from the smart phone's 120 location).

In some instances, the App 125 may instruct the user to take photos/videos of a particular part of the item 110. For example, if the item 110 is identified (by the user) as of a particular brand and/or category of that brand, then the App 125 may request the user take photos/videos of any one or more of the material care tag, seams, back of clasp, zipper brand logo, closeups, etc. Sometimes, the packaging of the item can be an indicator, thus needing on-site verification or photoing. These or other images may reveal specific details that are unique to that item's brand, which a counterfeiter may not take the care to replicate. Other instances include instructing the user to look for or touch, move, or shake a particular area of the item 110, and input into the App 125, the result of that experience. For example, for a watch stated to be made of gold, an evaluation of its weight into the App 125 would help determine if it really is gold or not. Or if the watch makes a ticking sound or not, etc.

Therefore, depending on the type of item being considered, various prompts or instructions to the user may be requested by the App 125. In some instances, there may be a pre-scan, pre-photo set of questioning offered to the user, by the App 125, to serve as a front-end filtering of the item 110. For example, in one embodiment, the App 125 may actually provide an image of an authentic item to the user, for the user to compare himself. In some instances, the App 125 may provide important facts that describe the item's features or qualities which distinguish it from a “fake.” Thus, the user can study the item 110 with the provided information to make his or her better-informed judgment. These pre-scan/photo session(s) may serve to altogether eliminate the item 110 as authentic, without proceeding to the next step in the App's sequence. A simple non-limiting example is if an authentic item is only made in a specific color or material type, which does not match the item under review. In one embodiment, the “front end” of the App 125 can provide an authentication score without requesting service from the Cloud system.

In some embodiments, the App 125 may instruct the user to hold the item 110 at a particular angle/position, may instruct the user to re-take a former taken picture. In one mode of the embodiment, the App 125 can perform a local picture quality verification 135 (i.e., “local” refers to within the smart phone 120 and not sending to the Cloud 150, for rapid verification). If the verification fails, the App 125 will prompt the user to retake some or all of the pictures.

Upon satisfying the App's initial requests (if so configured), the user-input data & images is uploaded 145 into cloud 150. Cloud 150 is connected to a system server 170 with memory and associated database(s) 175 containing comparative information regarding the item 110 being evaluated. In the simplest case, the comparative information can be original photos or images of the item, wherein the server 170 performs an image comparison and a degree of matching is made, resulting in a computed score. This score 185 is output 180 from the system server 170 (or some element of the system) back to the user's smart device 120, typically into the App 125. The computed score 185 being returned to the user is shown in this FIG. as part of large arrow 185 and connects to the smart device 120 via its communication channel 140.

In another aspect, an intermediary AI Cloud manager 160 may be implemented in the Cloud 150, as shown in this FIG. as an optional front-end-to-server 170 approach. Specifically, data (e.g., images, etc.) received from the user via cloud 150 can be processed by AI Cloud manager 160 which serves to “connect” to respective cloud-connected analysis engines/servers 162. For example, AI Cloud manager 160 may be informed that the item 110 is a “handbag” and therefore shuttle the user-provided (and if desired, ancillary information—e.g., location, etc.) data to a handbag tailored analysis engine 162. This handbag tailored analysis engine 162 could be part of the general 100 system or may involve connecting to database(s) from the item's manufacturer to acquire up-to-date item images or information. In some embodiments, the AI cloud manager 160 may transfer the user-provided data (as well as data from other cloud-connected sources) to the general analysis engine 162. An Artificial Intelligence (AI) engine could operate as a general analysis engine and be “requested” by the AI Cloud manager 160 that a particular item is being evaluated, and an authenticity scoring request is being made.

Before proceeding, it is understood that the AI Cloud manager 160 may simply be software running on the server 170 discussed above, and one or more of the aspects of the AI Cloud manager 160 are performed by the server 170. However, it is also understood that the AI Cloud manager 160 may also be a separate server or separate software module running on that separate server. Here, in FIG. 1 the AI Cloud manager 160 is shown as a separate element, so as to better illustrate the different functions being performed, and is not to be interpreted as limiting.

As an illustration of using the AI Cloud manager 160 to poll AI engines, upon determining a handbag image(s) is being sent by the user, the AI cloud manager 160 would retrieve a “Handbag” mode setting, send out the predefined “prompt” along with the images to a chosen AI engine 164 (e.g., ChatGPT), and request, for example, “Based on the images, evaluate the handbag's authenticity and provide a score between 0 and 100” to ChatGPT. Another style of AI request would be to ask another AI engine 166 (e.g., Gemini) “Please analyze these images focusing on the ability to find this on websites” and return with a confidence scale of authenticity.

Depending on the nature and the characteristic of available AI engines, Cloud AI Manager 160 might send more than a prompt to the AI engine(s) for achieve a more accurate result (by averaging out). For example, Cloud AI Manager 160 could request 3 times to Gemini simultaneously while request 1 time to ChatGPT. The result from all four queries could be averaged out, or a weighting performed.

The result of the AI query (whether of one or multiple engines) would be cataloged in server 170 for future reference, or for machine learning purposes, or to build a database wherein future queries may be directed to the server 170 instead of to AI engines. In some instances, the resulting score from an AI-based query could be compared to a similar “query” in server 170 and an averaging may be performed, or some weighting. Depending on the success rate of various AI engines, and economics, more or less reliance on server 170 may be used.

It is understood that the AI Cloud Manager 160 can, some embodiments, send a “dynamic-generated” prompt based on the images/items/AI engine, to a specific AI engine (e.g., 166). Such “dynamic-generated” prompt is determined in server 170 based on past result (stored in Database 175) and an internal Machine Learning Model (MLM). That is, the nature and type of AI query can be influenced by prior similar queries, records of which are held in DB 175 and with guidance from MLM. These features are understood to be illustrated in this FIG. as part of the AI Cloud Manager 160, but physically may be resident in server 170, or in Analysis Engine 162, etc.

An example of a Machine Learning Model (running on server 170 or other servers) could be where the location of the request fits a “blacked-list” geo-region (e.g., a well-known area for selling fake bags). If so, the exemplary method can apply an appropriate score-reduction factor just based on the location of the request. Another example is using a previous request and result stored in internal DB 175 to evaluate the current request. That is, while the location may be suspect, the actual images sent in by the user may prove differently, or other factors (e.g., recent queries from suspect location proved to all be highly authentic) may influence the authenticity evaluation. In this event, a weighted average score 185 is developed and sent to the user. Thus, a weighting based on location, etc. as well as sample size can influence the resulting score 185.

Upon receipt of a score 185, the user can decide to purchase 190 or not. This decision can be fed back into the system's server 170 for future reference. And the results along with the user-provided data/pictures can be stored in internal database 175. This information can become a tuning tool, if later the user discovers the item 110 is fake, wherein the system 100 can re-calibrate using its stored information.

As indicated in FIG. 1, a final score 185 is sent back to the user's smart phone/device 125. As noted above, in some instances, an iterative approach may be used, where the resulting score may not be sent (or prove to be indefinite) to the user because some parameter was insufficient and therefore the user is requested by server 170 or via the App 125 to perform additional tasks to better help the system 100 to determine authenticity. That is, in some instances, the exemplary system 100 may not initially request a full suite of images, actions, etc. from the user, but proceed with a first set of user-provided images, and qualify if the first set was indeed sufficient to provide a definitive score result. To appreciate this alternative, it may be the case where an item is very definitely non-authentic so that only one or two pictures from the user will be determinative. Thus, the user may need not perform a battery of photos, or examinations to “trigger a purchasing threshold” because the system 100 returned an authenticity score that was very low. Conversely, if the returned authenticity score is borderline, the system 100 (or App 125) may request a secondary battery of photos/examinations to arrive at an updated re-evaluation. Such a latter approach may facilitate a pay for authenticity service or premium service, while the former limited input may be a free service offered to the user.

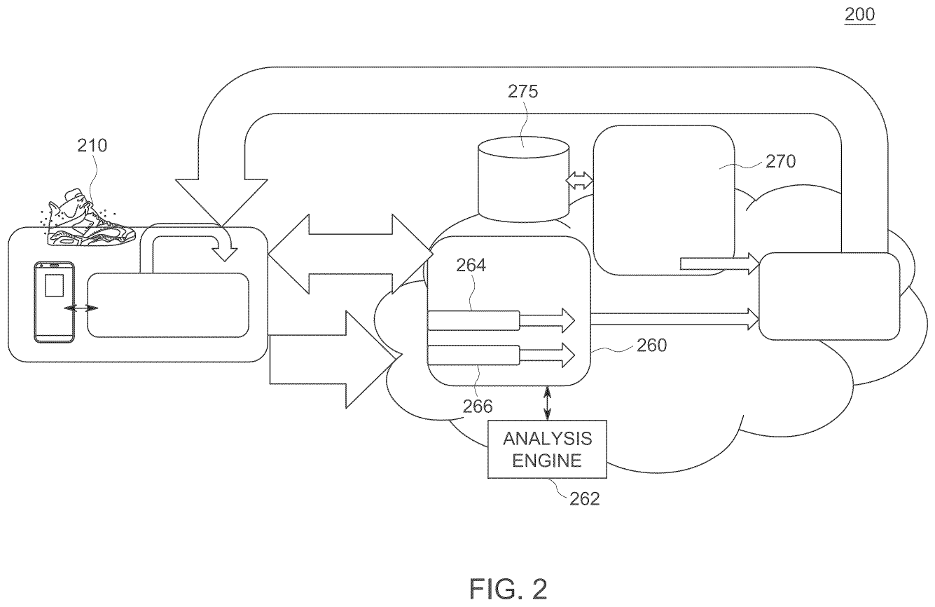

FIG. 2 is an illustration of an exemplary configuration 200 analogous to the embodiment shown in FIG. 1. However, a principal difference is the use of different AI engines 264, 266 and their evaluation. Additionally, the item under evaluation for this FIG. 2 is shown to be a pair of shoes 210. The general steps and approaches described in FIG. 1 are replicated, however, the AI Cloud manager 260, in evaluating the item 210 understands there are only a limited number of suitable AI engines (shown here as 264, 266). That is, AI Cloud manager 260 determines if the item type is best suited for different AI engines and in this instance, based on the configuration, there currently may only be two AI engine available for “Shoe” (ChatGPT 264 and Meta AI 266). The AI Cloud manager 260 then can, for example, send to ChatGPT 264, a single “prompt”, stating, for example, “Based on the images, evaluate the shoe's authenticity and provide a score between 0 and 100”. And a ChatGPT score can be obtained. For Meta AI 266, AI Cloud manager 260 can send out 3 parallel “prompts”, “Based on the images, analyze these images focusing on websites and facebook posting”. And the Meta AI 266 result can be weighted, averaged into a MetaAI score. Based on the weights from the configuration, the exemplary system 200 can calculate the weighted average: (ChatGPT score*75%)+ (MetaAI score*25%)=Cloud AI score. This resulting score can then be processed out to the user. Of course, other fractions or percentages may be used and other weighting schemes (e.g., recent accuracy, quantity of responses by AI engines, time of day, sale window, etc.).

In a similar situation, using location information, the exemplary system 200 can reduce the score by a factor, if the location is well known for fake shoes. Also, a weighting could be performed using data from the server 270 having a Machine Learning Model (with “dynamic-generated” prompt-described above) being dynamic weight based, on data in the Internal DB 275 or server 170 or Analysis Engine 161. In aggregate, a final weight score can be calculated, such as:

$$( ( Cloud\_AI \_score * ( 1 - internal\_weight ) ) + ( Internal\_AI \_score * Internal\_weight ) ) * ( 1 - Location\_reduction ) = Final\_score .$$

Of course, other fractions or percentages may be used and other weighting schemes may be implemented according to design preference.

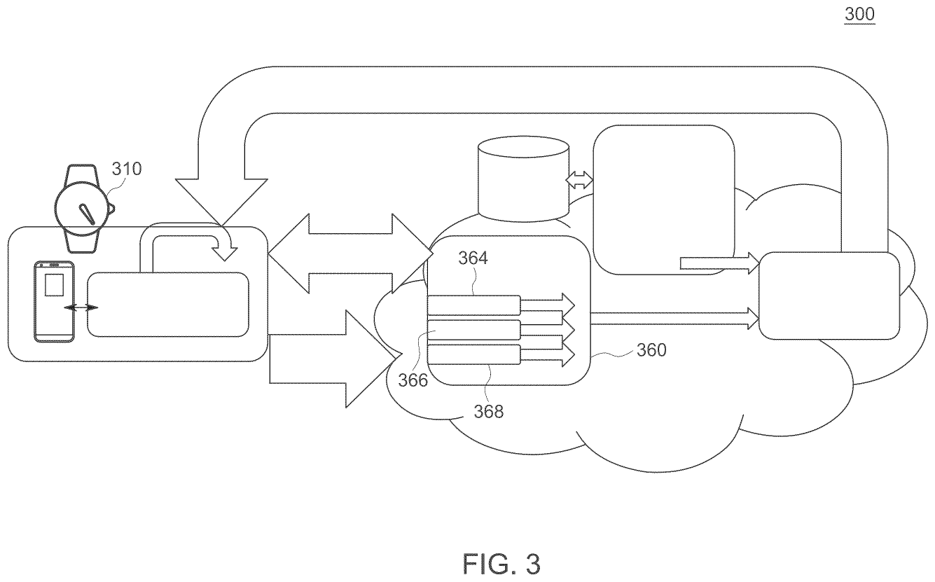

FIG. 3 is an illustration of an exemplary configuration 300 analogous to the embodiments shown in FIGS. 1 and 2. However, a principal difference is the use of different AI engines 364, 366, 368 and their evaluation. Additionally, the item under evaluation for this FIG. 3 is shown to be a watch 310, and for this example, an analysis engine is not illustrated, as not pertinent to this example (though one may be used). This system 300 proceeds in accordance with the procedures described above, however the AI Cloud manager 360, operates with “Watch” mode, and retrieves Watch's configuration. Based on the current configuration, only three AI engine are found available for “Watch” (ChatGPT 364, Gemini 366, and xAI 368). A similar querying approach is used and the resultant scores are averaged, weighted, etc. based on the number of “prompts” and queries sent to the respective AI engines. As well as the so-called “expertise” of the respective AI engine (some being better, having more resources than others). As one possible example, AI Cloud manager 360 for xAI, could send out 5 parallel “prompts”, “Based on the images, analyze these images focusing on websites and facebook posting”, and the result 5-averaged as an xAI score. An overall score can be calculated: (ChatGPT score*65%)+ (Gemini score*25%)+ (xAI score*10%)=Cloud AI score. Of course, the percentages and fractions and numbers used may vary, according to design preference. As above, location information may be used to alter the final score, as well as referencing a Machine Learning Model (with “dynamic-generated” prompt-described above)

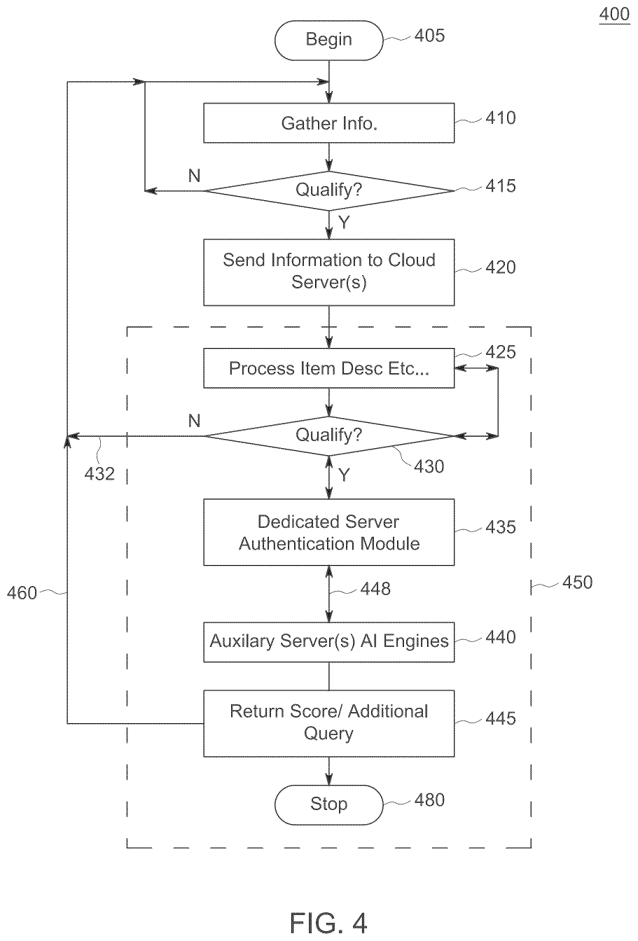

FIG. 4 is a flowchart 400 showing an exemplary process 400. The process 400 starts with User initiation 405 of the authenticity App. Upon initiation 405, initial data from the User is collected in step 410, such as item information, location, etc. as detailed above. The initial data is Qualified. Step 415 determines if the provided information/data is insufficient to proceed. If insufficient, the exemplary process 400 jumps to step 410 to request a re-submission or additional information. Step 415 may also serve as a preliminary filter, that is, analyzing the information/data itself for authenticity to provide an authenticity score. Aspects of this approach were discussed above.

If the information/data is insufficient to proceed, then it is transmitted 420 to the Cloud for handling by the server side of the system. Dashed block 450 encompasses the cloud-side part of the process 400. The received information/data is next processed by step 425 for any user registration (if needed), further evaluation, location data, etc. Connections to various analysis engines, servers, etc. may be queued in step 425 or in subsequent steps. Next, a server-side Qualification 430 is performed, including, if needed, image correction, adjustment, quality control, etc. If the received information/data does not meet a desired metric, then the server sends feedback 432 to the user, returning to step 410 with additional requests for information/data. Also, step 430 may re-poll step 425, requesting additional information, wherein step 425 may acquire that additional information from other servers (e.g., a handbag manufacturer, etc.), to send back down to step 430 for re-Qualification.

While step 430 operates to assure a sufficient caliber of information is obtained by the server, it may also serve as an authentication node. That is, preliminary scoring could be returned to the user based on the Qualification determination. One possible example is the location is identified as suspect, or a provided image clearly indicated a fake. Aspects of this were discussed above. If Qualification 430 is a success, then the received information/data is forwarded a dedicated server 435 or to a software module handling the authentication and scoring. In some embodiments, if there are no AI engines available, or the dedicated server 435 is sufficient to derive the authentication and scoring, then the exemplary process “skips” through step 440 to return an authentication score 445 to the user, or if additional information 460 is needed from the user. If the authentication score 445 is sent, then the exemplary process stops 480. If additional information is requested 460, the exemplary process 400 returns to step 410 and proceeds again.

If AI engines are available and chosen to be used, then the exemplary process moves from step 435 to step 440 to query its AI resources. Implications of a dynamic-generated prompt with Machine Learning Model are also possible. Upon AI evaluation, step 440 can forward its AI results to the dedicated server 435 for any averaging, weighting, etc. as indicated by the two-way arrow of 448. And then forwarding the final score 445 to the user, bypassing step 440, to then stop 480.

It is expressly understood the steps above may be further segregated into smaller steps or combined into larger steps/modules and that some steps/modules are optional.

It is understood that the specific order or hierarchy of steps in the processes disclosed is an example of exemplary approaches. Based upon design preferences, the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. Modules may used as reference to software, and engines may be used as reference to hardware and/or software performing particular forms of analysis and/or tasking.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An item authenticity evaluation system, comprising:
a computer-readable non-transitory medium having encoded thereon computer-executable instructions to:
evaluate a user-provided image of an item by comparing the image to one or more authentic images of the item;
determine a level of authenticity of the item;
generate a score correlated to the level of authenticity determined; and
an App configured for use on a portable smart device having image taking capabilities, wherein the App provides a client-side interface for the system and is configured to instruct the user to take one or more images of the item, to be evaluated by the system,
wherein the system provides a measure of authenticity of an item being considered by the user.

2. The system of claim 1, further comprising:
a communications network;
a smart device of the user having the App installed and configured to connect to the communications network; and
a server connected to the communications network, wherein the server is configured to execute one or more instructions of the computer-readable non-transitory memory.

3. The system of claim 2, further comprising a database containing at least one of reference images of the item, feature descriptions of the item, and a location metric associated with the item being considered by the user.

4. The system of claim 1, wherein the computer-executable instructions further include instructions to:
correspond with one or more artificial intelligence (AI) engines; and
provide results of the correspondence as data used for determining the level of authenticity of the item.

5. The system of claim 1, wherein the computer-executable instructions further include instructions to perform at least one of an image correction, adjustment, and quality control of the user-provided image.

6. The system of claim 3, wherein the computer-executable instructions further comprises:
instructions to perform at least one of a dynamic generated prompt to one or more artificial intelligence (AI) engines, with prompt parameters obtained from at least one of the server and database; and
a weighting of the level of authenticity.

7. The system of claim 4, wherein results of the correspondence data are weighted.

8. The system of claim 1, further comprising, an analysis engine in communication to the system, providing at least one of the comparing the image to the one or more authentic images of the item and determining a level of authenticity of the item.

9. The system of claim 1, wherein the computer-executable instructions further include instructions to the user for additional information of least one of different user-provided images, a description of the item, a name of location venue, and stated price of the item, wherein information received from the user is used to assist in authentication.

10. The system of claim 1, further comprising a machine learning model, wherein the App forwards a buy or not-buy decision from the user to the machine learning model.

11. The system of claim 10, wherein at least one or more of the instructions are located on the machine learning model, wherein the machine learning model dynamically alters the evaluation and determination instructions.

12. A method of providing a confidence level of authenticity of an item to a customer, comprising:
installing an App on a user's smart device, the App configured to instruct the user to take at least one of images and a video of an item desired for purchase;
sending the least one of images and video to a server-run application that evaluates the item within the at least one of images and video;
determining the item type and brand within at least one of the App and the server-run application;
comparing the at least one of images and video with images of an authentic item;
generating at least one of a score and score range based on the comparing; and
sending the at least one of score and score range to the App on the user's smart device,
wherein the method provides a measure of authenticity of the item.

13. The method of claim 12, wherein the comparing is accomplished by forwarding the least one of images and video to one or more artificial intelligence engines performing the evaluation, wherein the forwarding is based on a dynamic generated prompt using a machine learning model.

14. The method of claim 13, wherein a scoring of the one or more artificial intelligence engines is weighted.

15. The method of claim 12, wherein images of an authentic item are stored on at a database of the server running the evaluation or a database not local to the server.

16. The method of claim 12, wherein the sending the at least one of score and score range to the App, includes sending a request for additional information of least one of different user-provided images, a description of the item, a name of location venue, and stated price of the item, wherein information received from the user is used to assist in authentication.

17. A genuine item scanning authentication system, comprising:
a communications network;
a server connected to the communication network;
portable smart device configured to communicate to the communications network;
an App installed on the portable smart device, having image taking capabilities, wherein the App provides a client-side interface for the server and is configured to instruct a user to take one or more images an item under consideration, to be sent to the server;
an intake module hosted by the server, evaluating received one or more images from App, wherein the intake module is configured to perform at least one of image correction, adjustment, and quality control of the user-provided images, and return instructions to the user if additional images or information is required, or a preliminary authentication score;
an authentication module, comparing received information from the App with images of an authentic item and weighing a result of the comparing to arrive at an authentication score of the item under consideration; and
a reply module hosted by the server, sending the authentication score to at least one of the App and the portable smart device.

18. The system of claim 17, wherein the authentication module is in a form of dynamic generated prompt with Machine Learning Model adjusted queries to at least one or more artificial intelligence servers and analysis engines connected to the communications network.

19. The system of claim 18, further comprising one more databases containing at least one of the images of an authentic item, characteristics of the item, and a location parameter of the item under consideration, for use in the authentication score.

20. The system of claim 19, further comprising, storing a buy or not buy decision by the user.
